(19) United States
(12) Patent Application Publication
(10) Pub. No.: US 2026/0060473 A1
(43) Pub. Date: Mar. 5, 2026

(54) WAFFLE MAKER

(71) Applicant: Waffle University Co., Ltd., Seoul (KR)

(72) Inventors: Jeong Hee SON, Jeju-si (KR); Jin Woo JU, Seoul (KR)

(73) Assignee: Waffle University Co., Ltd., Seoul (KR)

(21) Appl. No.: 19/312,404

(22) Filed: Aug. 28, 2025

(30) Foreign Application Priority Data
Sep. 3, 2024 (KR) 10-2024-0119324

(51) Int. Cl. A47J 37/06; A47J 36/34

(52) U.S. Cl. CPC A47J 37/0611; A47J 36/34; A47J 2202/00

(57) ABSTRACT

The present disclosure relates to a waffle maker including: a main body; and a waffle pan detachably mounted to the main body, wherein the main body includes a first support part and a second support part, which are arranged in pairs spaced apart in a front-rear direction and are provided on an upper portion of the main body in multiple pairs in a width direction, and a plurality of waffle pans are detachably mounted. Each waffle pan includes a lower mold and an upper mold rotatably coupled to each other by a hinge.

### CROSS-REFERENCE TO RELATED APPLICATION

This application claims the benefit of Korean Patent Application No. 10-2024-0119324 filed on Sep. 3, 2024, in the Korean Intellectual Property Office, the entire disclosure of which is incorporated herein by reference for all purposes.

### BACKGROUND OF THE INVENTION

### Field of the Invention

The present disclosure relates to a waffle maker, and more specifically, to a waffle maker that is convenient and safe to use, has reduced failure rates, is easy to repair in case of failure, and is easy to maintain.

### Background Art

In general, a waffle is a type of Western confectionery made by making batter obtained by mixing flour, milk, eggs, etc., pouring the batter between two plates engraved with a honeycomb pattern, called waffle pans which are square, rectangular, circular, heart-shaped, or other shapes, and baking the batter until golden brown.

That is, waffles are popular food items made by pouring batter into a mold having a predetermined shape with metal plates on both sides and baking the batter. People often top waffles with butter or syrup.

FIG. 1 is a perspective view illustrating a conventional waffle maker with one side of an upper mold opened.

The conventional waffle maker includes a main body 1, a lower mold 2 detachably formed on an upper surface of the main body 1, and an upper mold 4 provided with an opening/closing handle 11 on the front and hinge-coupled to an upper portion of the main body via a protruding bracket 3 of the main body 1. The main body 1 has an inclined surface 5 formed on one side thereof, a temperature controller 6 and a timer 7 mounted on the inclined surface 5, waffle molding pans 8 with a concavo-convex shape installed facing each other in the upper and lower molds 4 and 2, and a heater embedded inside. In the drawings, reference numeral 14 denotes a lamp.

When the device is operated by the timer 7 and the temperature controller 6 provided on the inclined surface of the main body 1, power is supplied to the heater and a heater ground terminal inside the main body 1, and the waffle molding pans 8 in the upper and lower molds 4 and 2 are heated. Since the upper and lower molds 4 and 2 are used in a heated state, surfaces of the upper and lower molds 4 and 2 are coated for long-term use.

The preheated waffle molding pans 8 are filled with the batter evenly, then a filling material is placed on top, and another batter is poured over the filling material. Then, the upper mold 4 is closed by aligning the upper mold 4 with the lower mold 2 based on the protruding bracket 3 using the opening/closing handle 11. After a set time has elapsed as determined by the timer 7, the lamp 14 turns on and heating by the heater stops. A user checks the illuminated lamp 14 and opens the upper mold 4 to obtain the finished waffle.

In the conventional waffle maker described above, the lower mold 2 forming the waffle pan is integrally formed with the main body 1, making it difficult to repair in the event of a waffle pan failure. Additionally, the batter put in the waffle maker may overflow into the main body 1, causing damage to internal electrical components. Especially, in line with the recent trend of digitalization for user convenience, there is a problem in that the overflow may cause malfunction or failure of electronic components used for digital control.

### PATENT LITERATURE

### Patent Documents

Patent Document 1: Korean Utility Model Publication No. 20-2000-0007967

### SUMMARY OF THE INVENTION

Accordingly, the present disclosure has been made to solve the above-mentioned problems occurring in the prior arts, and it is an objective of the present disclosure to provide a waffle maker that is convenient and safe to use, has a low failure rate, and allows easy maintenance such as cleaning after waffle production.

To accomplish the above object, according to the present disclosure, there is provided a waffle maker including: a main body; and a waffle pan detachably mounted to the main body, wherein the main body includes a first support part and a second support part, which are arranged in pairs spaced apart in a front-rear direction and are provided on an upper portion of the main body in multiple pairs in a width direction, and a plurality of waffle pans are detachably mounted, wherein each waffle pan includes a lower mold and an upper mold rotatably coupled to each other by a hinge, wherein the lower mold includes a lower mold body, a lower mold heater joined to the lower mold body, and a lower mold cover provided below the lower mold body to cover the lower mold heater, and wherein the upper mold includes an upper mold body, an upper mold heater joined to the upper mold body, and an upper mold cover provided on the upper mold body 1331 to cover the upper mold heater.

Moreover, the first support part and the second support part are in the form of a rod-shaped hollow member, are fastened at lower portions to a top plate by mounting means, and include a first support coupling hole and a second support coupling hole respectively formed at the upper portions thereof for mounting the waffle pan. The lower mold cover includes a first front extension part protruding forward and a first rear extension part protruding rearward, respectively, the first front extension part is fixed to the first support part by fastening means coupled to the first support coupling hole and the first rear extension part is fixed to the second support part by fastening means coupled to the second support coupling hole, so that the waffle pan is mounted on upper portions of the first support part and the second support part. The lower mold body is provided above the lower mold cover. The lower mold body includes a front extension portion protruding forward and a rear extension portion protruding rearward, such that the front extension portion of the lower mold body is provided to cover the first front extension part 1315 of the lower mold cover and the rear extension portion of the lower mold body is provided to cover the first rear extension part of the lower mold cover. The lower mold body is coupled to the lower mold cover by a plurality of fastening means spaced along the edge thereof.

Furthermore, the lower mold has a space formed between the lower mold heater and the lower mold cover within the lower mold cover, and the upper mold has a space formed between the upper mold heater and the upper mold cover within the upper mold cover.

Additionally, the second support part includes a first connection hole penetrating forward and a second connection hole penetrating laterally. The first connection hole communicates with a lower mold through-hole formed at the rear of the lower mold cover, and is electrically connected to the lower mold heater via electric wires passing through the first connection hole and the lower mold through-hole. An upper mold through-hole is formed at the rear of the upper mold cover, and the upper mold cover is electrically connected to the upper mold heater via electric wires passing through the second connection hole and the upper mold through-hole.

In addition, the main body includes a main body part, which has a rear plate, a front plate spaced forward from the rear plate, side plates located on both sides in the width direction of the rear plate and the front plate, front and rear sides of each side plate being respectively joined to the rear plate and the front plate, and a top plate, wherein the top plate is provided on top of the rear plate, the front plate, and the side plates, and the first support part and the second support part are joined to the top plate to be positioned on the upper portion of the main body part. The top plate includes a first bent portion extending forward beyond the front plate and bent upward, and a second bent portion bent rearward from the top of the first bent portion.

The waffle maker according to the present disclosure is convenient and safe to use, has a low failure rate, is easy to repair in the event of a failure, and allows easy cleaning after waffle production.

### BRIEF DESCRIPTION OF THE DRAWINGS

FIG. 1 is a perspective view illustrating a conventional waffle maker.

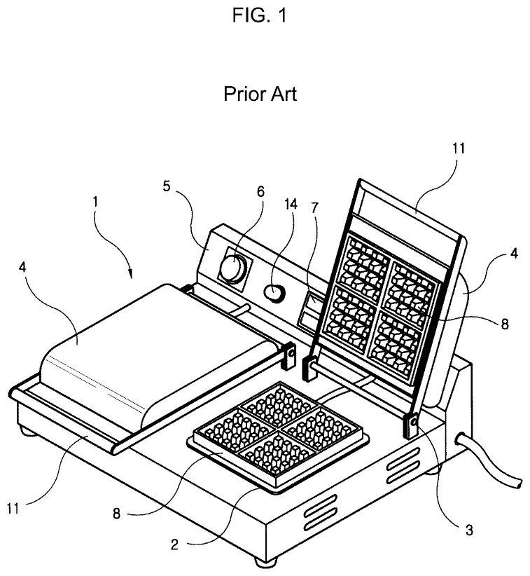

FIG. 2 is a perspective view illustrating a waffle maker according to the present disclosure with a single waffle pan installed.

FIG. 3 is a front view illustrating the waffle maker according to the present disclosure with the single waffle pan installed.

FIG. 4 is a cross-sectional view taken along line A-A of FIG. 3.

FIG. 5 is a front view illustrating an operation part of the waffle maker according to the present disclosure.

FIG. 6 is a plan view illustrating the waffle maker according to the present disclosure with the single waffle pan installed.

FIG. 7 is a cross-sectional view taken along line B-B of FIG. 6.

### DETAILED DESCRIPTION OF THE PREFERRED EMBODIMENT

All technical and scientific terms used in the description of the present disclosure, unless otherwise defined, have the meanings generally understood by those skilled in the art to which the present disclosure pertains. All terms used herein are intended to more clearly describe the present disclosure and are not intended to limit the scope of the present disclosure.

The expressions such as “comprising,” “including,” and “having” used in the description of the present disclosure are to be understood as open-ended terms that imply the possibility of including other embodiments, unless otherwise specified in the phrases or sentences in which they appear.

Singular forms used in the description of the present disclosure are intended to include the plural forms as well, unless the context clearly indicates otherwise, and the same applies to the claims.

Terms such as “first,” “second,” and the like used in the description of the present disclosure are intended only to distinguish between different components and do not imply any order or importance.

When a component is described as being “connected to” or “coupled to” another component in the present disclosure, it is to be understood that the component may be directly connected or coupled to the other component, or connected or coupled via another intervening component.

Hereinafter, a detailed description will be given of a waffle maker according to the present disclosure with reference to the accompanying drawings.

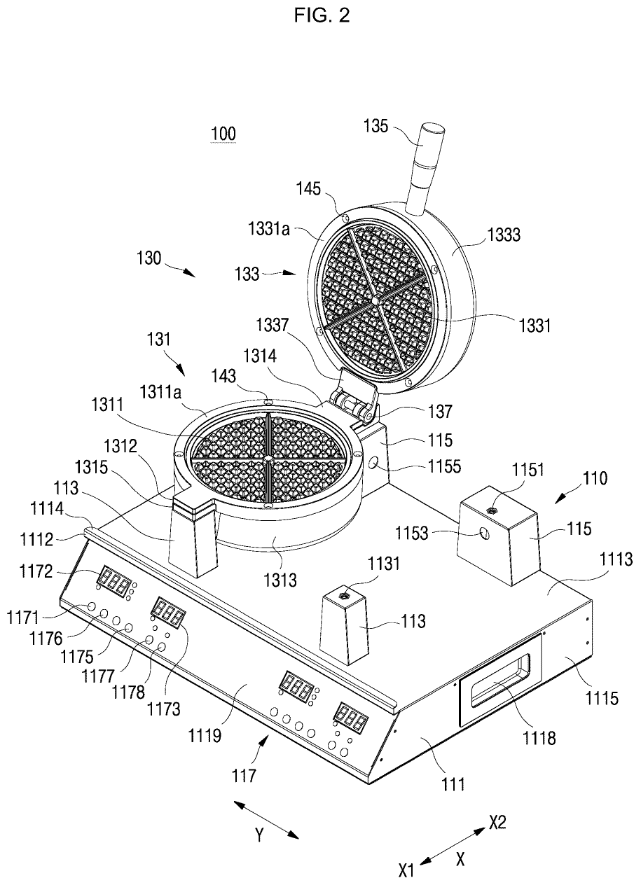

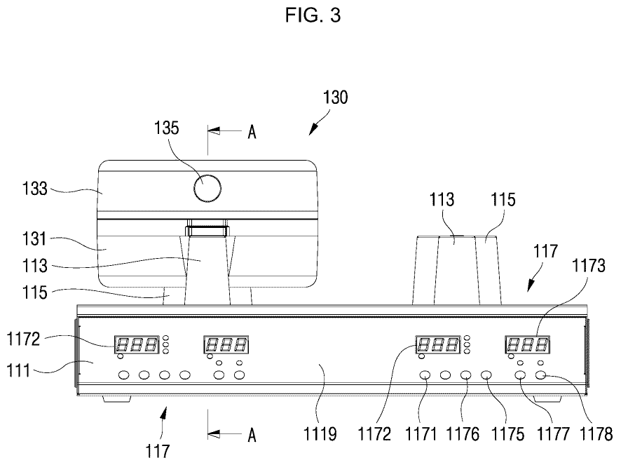

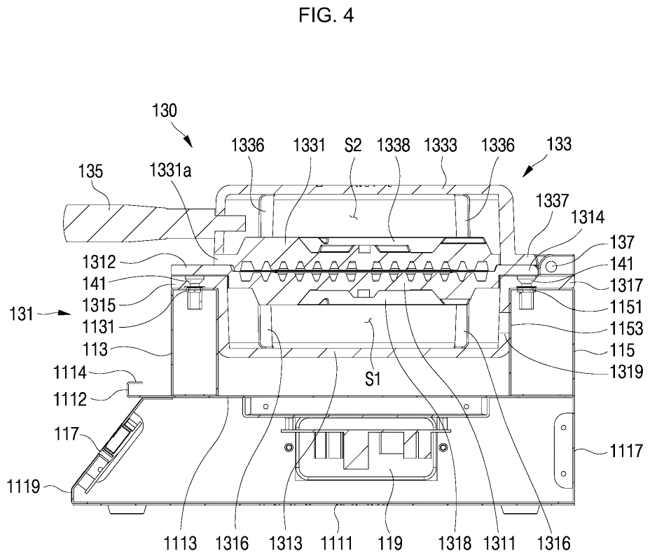

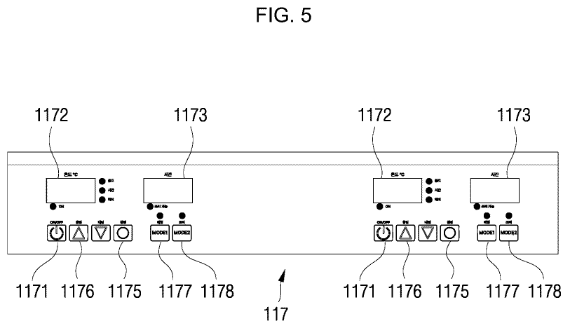

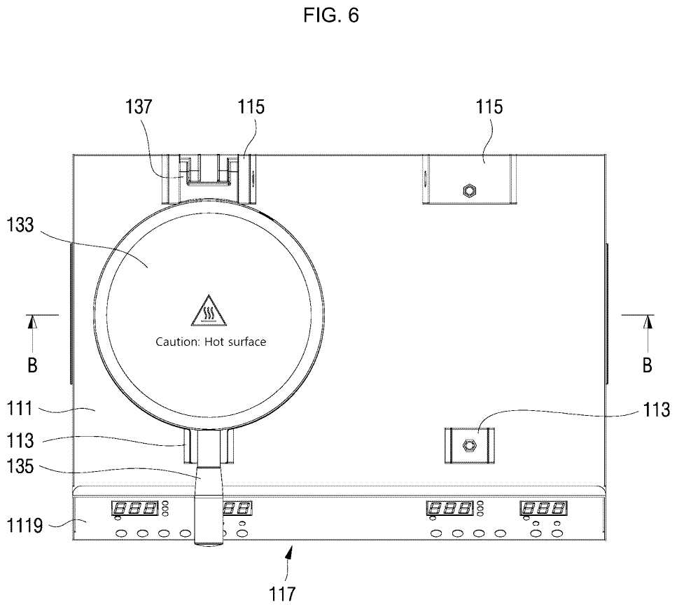

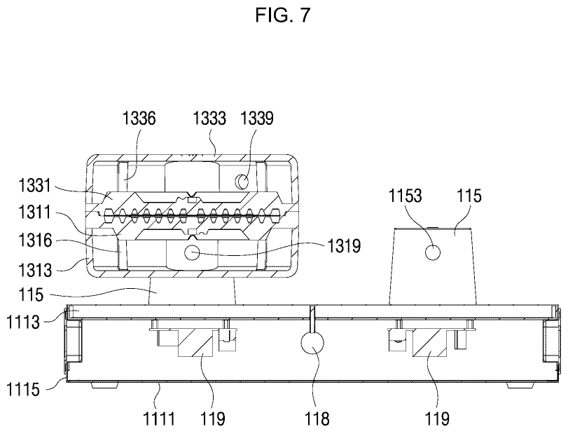

FIG. 2 is a perspective view illustrating a waffle maker according to the present disclosure with a single waffle pan installed, FIG. 3 is a front view illustrating the waffle maker according to the present disclosure with the single waffle pan installed, FIG. 4 is a cross-sectional view taken along line A-A of FIG. 3, FIG. 5 is a front view illustrating an operation part of the waffle maker according to the present disclosure, FIG. 6 is a plan view illustrating the waffle maker according to the present disclosure with the single waffle pan installed, and FIG. 7 is a cross-sectional view taken along line B-B of FIG. 6.

In the drawings, the left side of the main body 110 shows a state in which the waffle pan 130 is installed, and the right side shows a state in which the waffle pan 130 is not installed.

In the following description, in FIG. 2, the X-direction is defined as the front-rear direction, X1 as the front, and X2 as the rear, and the Y-direction is defined as the width direction.

As illustrated in FIG. 2, a waffle maker 100 according to the present disclosure includes the main body 110 and the waffle pan 130 detachably provided on the main body 110.

The main body 110 includes a main body part 111, a first support part 113, a second support part 115, and an operation part 117.

The main body part 111 includes a rear plate 1117, a front plate 1119, side plates 1115, and a top plate 1113.

The rear plate 1117 is a plate extending in the width direction.

The front plate 1119 is also a plate extending in the width direction and is spaced forward from the rear plate 1117. The front plate 1119 is inclined such that the height in the vertical direction decreases toward the front.

The side plates 1115 are plates extending in the front-rear direction and are positioned on both sides in the width direction between the rear plate 1117 and the front plate 1119. The front ends of the side plates 1115 are inclined such that the height in the vertical direction decreases toward the front. Both ends of the side plates 1115 in the front-rear direction of the side plates 1115 are coupled to the rear plate 1117 and the front plate 1119 by fastening means such as screws.

The top plate 1113 is formed in a rectangular plate shape and is provided on top of the rear plate 1117, the front plate 1119, and both side plates 1115. The front end of the top plate 1113 extends forward beyond the upper end of the front plate 1119. The rear and both lateral sides of the top plate 1113 are coupled to the rear plate 1117 and the side plates 1115 by fastening means such as screws.

The front end of the top plate 1113 is provided with a first bent portion 1112 bent upward, and a second bent portion 1114 bent rearward from the upper end of the first bent portion 1112. The second bent portion 1114 may be formed by being bent rearward from the upper end of the first bent portion 1112 and then bent upward. The first bent portion 1112 and the second bent portion 1114 are integrally formed with the top plate 1113.

The front end of the top plate 1113 extends beyond the front plate 1119 and includes the first bent portion 1112 bent upward, thus preventing batter from overflowing onto the front plate 1119 even if the batter overflows from the waffle pan 130. Moreover, the top plate 1113 further includes the second bent portion 1114 bent rearward from the upper end of the first bent portion 1112, thus further suppressing the batter overflow even when a large amount of the batter flows, and preventing a user from being injured during use by ensuring that the upper portion of the first bent portion 1112 does not end with a sharp edge.

The main body part 111 may further include a rectangular lower plate 1111 spaced downward from the top plate 1113. The lower plate 1111 is provided below the rear plate 1117, the front plate 1119, and both side plates 1115 in the width direction. The lower plate 1111 is spaced downward from the top plate 1113. The rear and lateral sides of the lower plate 1111 are fastened to the rear plate 1117 and the side plates 1115 using fastening means such as screws.

The main body part 111 has an internal installation space defined by the top plate 1113, the side plates 1115, the rear plate 1117, the front plate 1119, and the lower plate 1111. As illustrated in FIGS. 4 and 7, electrical and electronic components, such as a transformer 119, for operating the waffle maker 100 of the present disclosure are installed in the installation space. Description of the electrical and electronic components installed in the installation space is omitted.

In FIG. 7, reference numeral 118 denotes an AC power cable hole, and in FIG. 2, reference numeral 1118 denotes a carrying handle for lifting and transporting the waffle maker 100.

The first support part 113 and the second support part 115 are coupled to the top plate 1113 and are provided on the upper portion of the main body part 111. The first support part 113 and the second support part 115 are arranged in pairs spaced in the front-rear direction, and a plurality of such pairs are provided along the width direction. A single waffle pan 130 is detachably mounted between each pair of the first and second support parts 113 and 115.

The first support part 113 is provided in the form of a rod-shaped hollow member. The first support part 113 is positioned toward the front of the top plate 1113. A plurality of coupling holes penetrating in the vertical direction are formed in the lower portion of the first support part 113 and are fastened to the top plate 1113 by fastening a plurality of mounting means such as screws. A first support coupling hole 1131 penetrating in the vertical direction is formed in the upper portion of the first support part 113 to allow mounting of the waffle pan 130.

The second support part 115 is also formed as a rod-shaped hollow member. The second support part 115 is positioned toward the rear of the top plate 1113. The second support part 115 includes a plurality of coupling holes formed in the lower portion thereof and penetrating in the vertical direction, and the lower portion of the second support part 115 is fastened to the top plate 1113 by fastening a plurality of mounting means such as screws. The second support part 115 includes a second support coupling hole 1151 formed in the upper portion thereof and penetrating in the vertical direction to allow mounting of the waffle pan 130.

The second support part 115 is further provided with a first connection hole 1153 formed through the front side and a second connection hole 1155 formed through the side. The second connection hole 1155 is formed to penetrate toward the inside in the width direction of the second support part 115. Electric wires connected to the electrical and electronic components installed in the installation space of the main body part 111 pass through the first connection hole 1153 and the second connection hole 1155 and are connected to the waffle pan 130.

The electric wire extending through the first connection hole 1153 is connected to a lower mold 131 of the waffle pan 130, and the electric wire extending through the second connection hole 1155 is connected to an upper mold 133 of the waffle pan 130.

The first support part 113 and the second support part 115 are formed as rod-shaped hollow members, making them easy to manufacture. The first support part 113 and the second support part 115 serve to support the front and rear sides of the waffle pan 130 and are separately installed, thus allowing for easy replacement in the event of damage or failure and resulting in reduced repair costs and easy manufacturing.

The operation part 117 is installed on the front plate 1119 to control the operation of the waffle pan 130. The operation part 117 is configured in a digital format. Since the operation part 117 is provided in the digital format, the operation part 117 completely prevents the intrusion of foreign substances when contaminants adhere to the front plate 1119, and allows the user to clean easily.

As illustrated in FIGS. 2 and 5, the operation part 117 includes a power button 1171 for turning the waffle maker 100 on and off, a temperature display 1172 for visually displaying temperature of the waffle pan 130, a time display 1173 for visually displaying heating time of the waffle pan 130, a setting button 1175 for setting the temperature and time of the waffle pan 130, an adjustment button 1176 for adjusting temperature and cooking time of the waffle pan 130, a preheating button 1177 for preheating the waffle pan 130, and a cooking button 1178 for cooking with the waffle pan 130.

The operation part 117 allows intuitive temperature and time confirmation via the temperature display 1172 and the time display 1173, making it easy to check settings.

The power button 1171, the temperature display 1172, the time display 1173, the setting button 1175, the adjustment button 1176, the preheating button 1177, and the cooking button 1178 of the operation part 117 may be provided in plurality. In the present disclosure, for example, the displays and the buttons may be located at installation positions of multiple waffle pans 130.

As illustrated in FIG. 5, a temperature lamp, a time lamp, and an error lamp may be further provided adjacent to the temperature display 1172. A preheating lamp may be provided adjacent to the preheating button 1177, and a cooking lamp may be provided adjacent to the cooking button 1178.

When the user presses the setting button 1175 once, the temperature lamp is turned on, and the temperature can be adjusted using the adjustment button 1176. When the user presses the setting button 1175 twice, the time lamp is turned on, and the time can be adjusted using the adjustment button 1176.

The error lamp is illuminated when an abnormality occurs in the operation part 117 or in components, such as the temperature sensor, connected to the waffle pan 130.

The preheating lamp blinks when preheating is set, and the cooking lamp turns on during cooking.

The operation part 117 turns the power on or off when the power button 1171 is pressed. The default settings of the waffle maker 100 are a preheating temperature of 100° C., a cooking temperature of 180° C., and a cooking time of 2 minutes.

The cooking procedure using the operation part 117 is as follows: when the power button 1171 is pressed, the power is turned on, the waffle pan 130 is heated to the preset cooking temperature, and the cooking lamp is turned on. When the cooking button 1178 is pressed, cooking begins. To repeat cooking after completion of cooking, pressing the cooking button 1178 again initiates the next cooking cycle.

If cooking is not continued after completion, pressing and holding the preheating button 1177 for more than 3 seconds lowers the temperature to the preset preheating temperature and switches the mode to a standby mode. Pressing the preheating button 1177 once more cancels the preheating, and the temperature begins to rise. When the temperature reaches the cooking-ready temperature, the cooking lamp turns on.

As described above, when cooking is not performed, pressing and holding the preheating button 1177 for more than 3 seconds allows the operation part 117 to remain in the standby mode, resulting in energy savings, reduced electricity costs, extended service life of the waffle pan 130, and reduced maintenance costs.

The waffle pan 130 is detachably mounted to the main body 110. The plurality of waffle pans 130 are detachably mounted to the main body 110 with spacing in the width direction. Each waffle pan 130 is detachably mounted between a pair of the first support part 113 and the second support part 115. The waffle pan 130 is spaced above the top plate 1113 of the main body part 111 to form a gap.

The waffle pan 130 includes the lower mold 131 and the upper mold 133, which are rotatably coupled by a hinge 137.

The lower mold 131 is spaced from the top plate 1113 of the main body part 111 at a predetermined distance. The front and rear portions of the lower mold 131 are respectively coupled and fixed to the first support part 113 and the second support part 115 of the main body 110. The lower mold 131 includes a lower mold cover 1313, a lower mold body 1311, and a lower mold heater 1318.

The lower mold cover 1313 is formed as an upwardly concave hollow body. The cross-section of the lower mold cover 1313 may have various shapes such as square, rectangular, circular, and heart shapes, depending on the shape of the lower mold body 1311.

The lower mold cover 1313 includes a first front extension part 1315 and a first rear extension part 1317.

The first front extension part 1315 protrudes forward from the front side of the lower mold cover 1313. The first front extension part 1315 is fixedly mounted to the first support part 113 by fastening means 141 inserted into the first support coupling hole 1131.

The first rear extension part 1317 of the lower mold cover protrudes rearward from the rear side of the lower mold body 1311. The first rear extension part 1317 is fixedly mounted to the second support part 115 by fastening means 141 inserted into the second support coupling hole 1151.

The first rear extension part 1317 of the lower mold cover includes a hinge hole penetrating in the width direction. The first rear extension part 1317 may further include protrusions spaced apart in the width direction and extending upward, and hinge holes formed through the protrusions in the width direction.

The lower mold 131 is fixedly mounted on the upper sides of the first support part 113 and the second support part 115 by the fastening means 141 through the first front extension part 1315 and first rear extension part 1317 of the lower mold cover 1313, so that the waffle pan 130 is securely installed on the main body 110.

The lower mold body 1311 is formed as a plate. The lower mold body 1311 may be formed in various shapes such as square, rectangular, circular, and heart shapes. The lower mold body 1311 is positioned to face the upper mold body 1331 of the upper mold 133. A honeycomb-like pattern for forming the waffle shape is formed on the surface of the lower mold body 1311 facing the upper mold body 1331.

The lower mold body 1311 is inserted into the lower mold cover 1313 from the top of the lower mold cover 1313. The lower mold body 1311 includes a cover portion 1311a which extends laterally outward from the top and along the edge of the lower mold body 1311. The cover portion 1311a is provided to cover the upper end of the lower mold cover 1313.

The lower mold body 1311 further includes a front extension portion 1312 and a rear extension portion 1314 respectively extending forward and rearward from the cover portion 1311a.

The front extension portion 1312 protrudes forward from the front of the lower mold body 1311. The front extension portion 1312 is provided to cover an area where the first front extension part 1315 of the lower mold cover and the first support part 113 are coupled by the fastening means 141.

The rear extension portion 1314 protrudes rearward from the rear of the lower mold body 1311. The rear extension portion 1314 is provided to cover an area where the first rear extension part 1317 of the lower mold cover and the second support part 115 are coupled by the fastening means 141.

A rib 1316 which is opened upward and has an internal thread formed therein is provided inside the lower mold cover 1313. The cover portion 1311a includes a plurality of screw holes spaced along the edge thereof and penetrating in the vertical direction. The screw holes are formed at positions where the ribs 1316 are formed.

The lower mold body 1311 is provided above the lower mold cover 1313, and fastening means 143 such as screws or bolts are joined through the screw holes of the lower mold body 1311 and the ribs 1316 of the lower mold cover 1313 to securely couple the lower mold body 1311 to the lower mold cover 1313.

The front extension portion 1312 and the rear extension portion 1314 of the lower mold body 1311 are provided to cover the areas where the lower mold cover 1313 and the first support part 113 and the second support part 115 are joined, thus preventing batter leaking from the lower mold body 1311 from entering between the lower mold cover 1313 and the first and second support parts 113 and 115, and facilitating cleaning and maintenance.

The lower mold heater 1318 is mounted beneath the lower mold body 1311, inside the lower mold cover 1313. The lower mold cover 1313 has a lower mold through-hole 1319 formed at the rear side thereof to communicate with the first connection hole 1153 of the second support part 115. The lower mold heater 1318 is electrically connected via a wire that passes through the first connection hole 1153 and the lower mold through-hole 1319, and is heated by the electricity supplied through the wire. The illustration and description of the wire connected to the lower mold heater 1318 will be omitted. The lower mold heater 1318 may be equipped with a temperature sensor (not shown) that is connected to the operation part 117.

The lower mold 131 is configured such that the lower mold cover 1313 covers the lower mold heater 1318, and a space S1 is formed between the lower mold heater 1318 and the lower mold cover 1313, inside the lower mold cover 1313.

The heating temperature of the lower mold heater 1318 is around 200° C. The space S1 formed between the lower mold heater 1318 and the lower mold cover 1313 suppresses heat loss generated from the lower mold heater 1318 and further suppresses the transmission of heat from the lower mold heater 1318 to the top plate 1113.

Furthermore, since the lower mold 131 is spaced apart from the top plate 1113 of the main body part 111, the heat from the lower mold 131 is not directly transmitted to the main body part 111, thus preventing failure of electrical or electronic components installed inside the main body 110 due to heating, preventing the reduction in service life, and reducing the risk of burns to the user by avoiding heating of the main body part 111.

The upper mold 133 is provided above the lower mold 131. The rear side of the upper mold 133 is rotatably connected to the lower mold 131 via a hinge 137. The upper mold 133 includes an upper mold cover 1333, an upper mold body 1331, and an upper mold heater 1338.

The upper mold cover 1333 is formed as a downwardly concave hollow body. The cross-section of the upper mold cover 1333 may have various shapes such as square, rectangular, circular, and heart shapes depending on the shape of the upper mold body 1331.

The upper mold cover 1333 includes a second rear extension part 1337.

The second rear extension part 1337 of the upper mold cover protrudes rearward from the rear side of the upper mold cover 1333. The second rear extension part 1337 includes a hinge hole penetrating in the width direction, and protrusions that protrude downward and are spaced apart in the width direction. Each of the protrusions has a hinge hole formed through the protrusion in the width direction.

The second rear extension part 1337 of the upper mold cover is inserted between the protrusions formed on the first rear extension part 1317 of the lower mold cover, and a pin is inserted through the hinge holes of the second rear extension part 1337 of the upper mold cover and the first rear extension part 1317 of the lower mold cover to form a hinge 137. The upper mold 133 is rotatably connected to the first rear extension part 1317 of the lower mold cover via the hinge 137 formed by the second rear extension part 1337.

In FIG. 2, reference numeral 135 denotes a handle provided on the upper mold 133. In FIG. 2, the handle 135 protrudes forward from the front side of the upper mold cover 1333, but may be formed to protrude upward from the top side of the upper mold cover 1333.

The upper mold body 1331 is formed as a plate. The upper mold body 1331 is formed in the same shape as the lower mold body 1311, and may be formed in various shapes such as square, rectangular, circular, and heart shapes. The upper mold body 1331 is disposed to face the lower mold body 1311. The upper mold body 1331 has a pattern such as a honeycomb pattern for forming the waffle shape formed on the surface of the upper mold body 1331 facing the lower mold body 1311.

The upper mold body 1331 is inserted into the upper mold cover 1333 from the lower portion of the upper mold cover 1333. The upper mold body 1331 includes an upper mold cover portion 1331a extending laterally outward from the bottom and along the edge of the upper mold body 1331. The upper mold cover portion 1331a is configured to cover the lower end of the upper mold cover 1333.

A rib 1336 which is opened downward and has an internal thread formed therein is provided inside the upper mold cover 1333. The upper mold cover portion 1331a includes a plurality of screw holes spaced along the edge thereof and penetrating in the vertical direction. The screw holes are formed at positions where the ribs 1336 are formed.

The upper mold body 1331 is provided beneath the upper mold cover 1333, and fastening means 145 such as screws or bolts are joined through the screw holes of the upper mold body 1331 and the ribs 1336 of the upper mold cover 1333 to securely couple the upper mold body 1331 to the upper mold cover 1333.

The upper mold cover portion 1331a of the upper mold body 1331 is configured to cover the lower end of the upper mold cover 1333, thus preventing batter discharged from the waffle pan 130 from entering between the upper mold cover 1333 and the upper mold body 1331, and facilitating cleaning.

The upper mold heater 1338 is provided inside the upper mold cover 1333 and is coupled to the upper side of the upper mold body 1331. The upper mold cover 1333 includes a mold through-hole 1339 formed in the rear portion thereof. Electric wires that extend through the second connection hole 1155 and the mold through-hole 1339 are connected to the upper mold heater 1338, such that the upper mold heater 1338 is heated by electricity supplied through the electric wires. Description and illustration of the electric wires connected to the upper mold heater 1338 will be omitted. A temperature sensor (not shown), connected to the operation part 117, may be provided on the upper mold heater 1338.

The upper mold 133 is configured such that the upper mold cover 1333 covers the upper mold heater 1338, and a space S2 is formed between the upper mold heater 1338 and the upper mold cover 1333 within the upper mold cover 1333.

The heating temperature of the upper mold heater 1338 is approximately 200° C. The space S2 formed between the upper mold heater 1338 and the upper mold cover 1333 helps to suppress heat loss from the upper mold heater 1338.

In addition, the waffle pan 130 is configured such that the lower mold body 1311 is detachable from the lower mold cover 1313, and the upper mold body 1331 is detachable from the upper mold cover 1333. As a result, when it is necessary to replace the lower mold body 1311 or the upper mold body 1331, or when it is required to repair or replace the heaters, the repair and replacement can be easily performed.

Although the waffle maker according to the present disclosure has been described above with reference to the embodiments illustrated in the drawings, the embodiments are merely illustrative examples, and it will be understood by those skilled in the art that various modifications and equivalent alternatives may be made. Therefore, the true scope of protection should be defined by the technical spirit of the appended claims.

What is claimed is:

1. A waffle maker comprising:
a main body; and
a waffle pan detachably mounted to the main body,
wherein the main body includes a first support part and a second support part, which are arranged in pairs spaced apart in a front-rear direction and are provided on an upper portion of the main body in multiple pairs in a width direction, and a plurality of waffle pans are detachably mounted,
wherein each waffle pan includes a lower mold and an upper mold rotatably coupled to each other by a hinge,
wherein the lower mold includes a lower mold body, a lower mold heater joined to the lower mold body, and a lower mold cover provided below the lower mold body to cover the lower mold heater, and
wherein the upper mold includes an upper mold body, an upper mold heater joined to the upper mold body, and an upper mold cover provided on the upper mold body 1331 to cover the upper mold heater.

2. The waffle maker according to claim 1, wherein the first support part and the second support part are in the form of a rod-shaped hollow member, are fastened at lower portions to a top plate by mounting means, and include a first support coupling hole and a second support coupling hole respectively formed at the upper portions thereof for mounting the waffle pan,
wherein the lower mold cover includes a first front extension part protruding forward and a first rear extension part protruding rearward, respectively, the first front extension part is fixed to the first support part by fastening means coupled to the first support coupling hole and the first rear extension part is fixed to the second support part by fastening means coupled to the second support coupling hole, so that the waffle pan is mounted on upper portions of the first support part and the second support part,
wherein the lower mold body is provided above the lower mold cover,
wherein the lower mold body includes a front extension portion protruding forward and a rear extension portion protruding rearward, such that the front extension portion of the lower mold body is provided to cover the first front extension part of the lower mold cover and the rear extension portion of the lower mold body is provided to cover the first rear extension part of the lower mold cover, and
wherein the lower mold body is coupled to the lower mold cover by a plurality of fastening means spaced along the edge thereof.

3. The waffle maker according to claim 2, wherein the lower mold has a space formed between the lower mold heater and the lower mold cover within the lower mold cover, and the upper mold has a space formed between the upper mold heater and the upper mold cover within the upper mold cover.

4. The waffle maker according to claim 3, wherein the second support part includes a first connection hole penetrating forward and a second connection hole penetrating laterally,
wherein the first connection hole communicates with a lower mold through-hole formed at the rear of the lower mold cover, and is electrically connected to the lower mold heater via electric wires passing through the first connection hole and the lower mold through-hole, and
wherein an upper mold through-hole is formed at the rear of the upper mold cover, and the upper mold cover is electrically connected to the upper mold heater via electric wires passing through the second connection hole and the upper mold through-hole.

5. The waffle maker according to claim 1, wherein the main body includes a main body part, which has a rear plate, a front plate spaced forward from the rear plate, side plates located on both sides in the width direction of the rear plate and the front plate, front and rear sides of each side plate being respectively joined to the rear plate and the front plate, and a top plate, wherein the top plate is provided on top of the rear plate, the front plate, and the side plates, and the first support part and the second support part are joined to the top plate to be positioned on the upper portion of the main body part, and
wherein the top plate includes a first bent portion extending forward beyond the front plate and bent upward, and a second bent portion bent rearward from the top of the first bent portion.
